(19) United States
(12) Patent Application Publication
(10) Pub. No.: US 2025/0145046 A1
(43) Pub. Date: May 8, 2025

(54) MANAGEMENT APPARATUS, MANAGEMENT SYSTEM, TERMINAL APPARATUS, AND NON-TRANSITORY COMPUTER READABLE STORAGE MEDIUM

(71) Applicant: HONDA MOTOR CO., LTD., Tokyo (JP)

(72) Inventor: Seiichiro KONDO, Tokyo (JP)

(21) Appl. No.: 18/935,671

(22) Filed: Nov. 4, 2024

(30) Foreign Application Priority Data
Nov. 6, 2023 (JP) 2023-189464

(51) Int. Cl. B60L 53/68; B60L 53/62

(52) U.S. Cl. CPC B60L 53/68; B60L 53/62

(57) ABSTRACT

A management apparatus of an embodiment includes an input and a storage. The input receives input of success-failure information indicating whether or not a moving body has been successfully charged by a charger, charger identification information identifying the charger, and type identification information identifying the type of moving body. The storage stores, in a storage device, the result of charge of the moving body whose type is identified by the type identification information by the charger identified by the charger identification information based on the information input to the input such that the charger used for charge and the type of moving body targeted for charge are recognized.

This application is based on and claims the benefit of priority from Japanese Patent Application No. 2023-189464, filed on Nov. 6, 2023, the content of which is incorporated herein by reference.

### BACKGROUND OF THE INVENTION

### Field of the Invention

The present invention relates to a management apparatus, a management system, a terminal apparatus, and a non-transitory computer readable storage medium.

### Related Art

There are various services for providing the status of operation of a charger for a vehicle.
Patent Document 1: Japanese Unexamined Patent Application, Publication No. 2020-124061

### SUMMARY OF THE INVENTION

However, none of these services provide the status of charge of each vehicle type. For this reason, in a case where the charger cannot charge the vehicle due to compatibility with the vehicle type, a user of the service may lose an opportunity to charge a user's own vehicle even through the vehicle is actually chargeable. Conversely, in some cases, the user's own vehicle cannot be charged by a charger available for charging the vehicle by the service.

The problems to be solved by an embodiment of the present invention is to provide a management apparatus, a management system, a terminal apparatus, and a computer readable storage medium capable of grasping the status of charge of each type of moving body by a charger.

A management apparatus of an embodiment includes an input and a storage. The input receives input of success-failure information indicating whether or not a moving body has been successfully charged by a charger, charger identification information identifying the charger, and type identification information identifying the type of moving body. The storage stores, in a storage device, the result of charge of the moving body whose type is identified by the type identification information by the charger identified by the charger identification information based on the information input to the input such that the charger used for charge and the type of moving body targeted for charge are recognized.

According to the present invention, the status of charge of each type of moving body by the charger can be grasped.

### BRIEF DESCRIPTION OF THE DRAWINGS

FIG. 1 is a block diagram showing one example of the configuration of a management system according to an embodiment and the configuration of main components of the management system;

FIG. 2 is a flowchart showing one example of processing by a processor of a terminal apparatus of FIG. 1;

FIG. 3 is a flowchart showing one example of the processing by the processor of the terminal apparatus of FIG. 1;

FIG. 4 is a flowchart showing one example of processing by a processor of a server apparatus of FIG. 1;

FIG. 5 is one example of a history table; and

FIG. 6 is one example of a success-failure table.

### DETAILED DESCRIPTION OF THE INVENTION

Hereinafter, a management system according to an embodiment will be described with reference to the drawings. Note that in each drawing used for describing the following embodiment, the scale of each component may be changed as necessary. Moreover, in each drawing used for describing the following embodiment, some components may be omitted for the sake of convenience in description. Further, in each drawing and the present specification, the same reference numerals denote similar components.

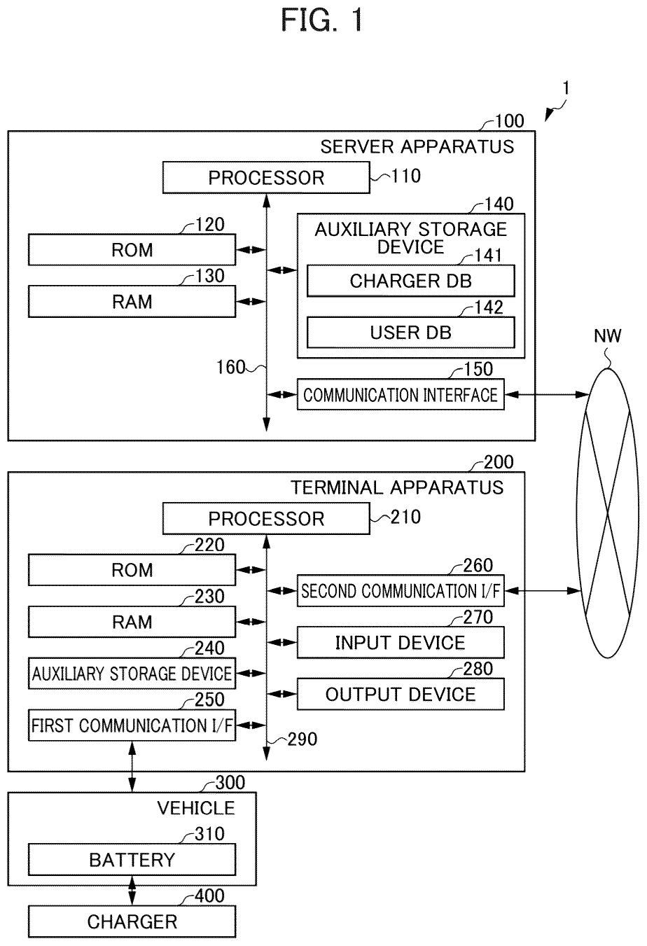

FIG. 1 is a block diagram showing one example of the configuration of a management system 1 according to the embodiment and the configuration of main components of the management system 1. Note that each component of the apparatus may be a built-in component or an external component. The management system 1 manages information on whether or not each charger 400 successfully charges a vehicle 300. Moreover, the management system 1 provides a charger information service. The management system 1 includes, as one example, a server apparatus 100, a terminal apparatus 200, the vehicle 300, and the charger 400. Note that the management system 1 may include some of these components. The number of each type of apparatus is not limited, but typically, the number of terminal apparatuses 200, the number of vehicles 300, and the number of chargers 400 are plural numbers.

The server apparatus 100 and the terminal apparatus 200 are connected to a network NW. The network NW is typically a communication network including the Internet. The network NW is typically a communication network including a wide area network (WAN). The vehicle 300 may also be connected to the network NW. The charger 400 may also be connected to the network NW.

The server apparatus 100 is a server as the center of the management system 1. Moreover, the server apparatus 100 provides the charger information service. The server apparatus 100 includes, as one example, a processor 110, a read-only memory (ROM) 120, a random-access memory (RAM) 130, an auxiliary storage device 140, and a communication interface 150. These components are connected to each other via, e.g., a bus 160. Note that the server apparatus 100 is one example of a management apparatus.

The processor 110 is a center component of a computer that performs processing necessary for operation of the server apparatus 100, such as arithmetic processing and control, and performs various types of arithmetic processing and processing. The processor 110 includes, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), and a field-programmable gate array (FPGA). Alternatively, the processor 110 may be a combination of some of these components. Alternatively, the processor 110 may be a combination of these components and, e.g., a hardware accelerator. The processor 110 controls each component to implement various functions of the server apparatus 100 based on programs stored in the ROM 120 or the auxiliary storage device 140, such as firmware, system software, and application software. Moreover, the processor 110 executes later-described processing based on these programs. Note that some or all of the programs may be incorporated into a circuit of the processor 110.

The ROM 120 and the RAM 130 are main storage devices of the computer having the processor 110 as the center. The ROM 120 is a non-volatile memory used solely for reading data. The ROM 120 stores, for example, the firmware among the above-described programs. Moreover, the ROM 120 also stores, e.g., data used when the processor 110 performs various types of processing.

The RAM 130 is a memory used for reading and writing data. The RAM 130 is used as, e.g., a work area for storing data temporarily used when the processor 110 performs various types of processing. The RAM 130 is typically a volatile memory.

The auxiliary storage device 140 is an auxiliary storage device of the computer having the processor 110 as the center. The auxiliary storage device 140 includes, for example, an electric erasable programmable read-only memory (EEPROM), a hard disk drive (HDD), and a flash memory. The auxiliary storage device 140 stores, for example, the system software and the application software among the above-described programs. Moreover, the auxiliary storage device 140 stores, e.g., data used when the processor 110 performs various types of processing, data generated by the processing of the processor 110, and various setting values. The data stored in the auxiliary storage device 140 includes, as one example, a charger database (DB) 141 and a user database (DB) 142. The auxiliary storage device 140 is one example of a storage device.

The charger DB 141 is a database that stores and manages information on the charger 400. The charger DB 141 includes, as one example, a charger table, a history table, and a success-failure table.

The charger table stores information on each charger 400 in association with a charger identifier (ID). This information includes location information indicating the installation location of the charger 400. The charger ID is identification information uniquely provided to each charger 400.

The history table is a table storing the history of charge of the vehicle 300 by the charger 400.

The success-failure table is a table storing information on the result of charge of the vehicle 300 by each charger 400. The success-failure table will be described later in detail.

The user DB 142 is a database that stores and manages information on a user (hereinafter merely referred to as a “user”) of the charger information service and the vehicle 300 used by the user. The user DB 142 includes, as one example, a user table, a vehicle table, and an incentive table.

The user table is a table storing the vehicle 300 used by each user. The user table stores a user ID and the vehicle ID of the vehicle 300 used by a user identified by the user ID in association with each other. The user ID is identification information uniquely provided to each user. The vehicle ID is identification information uniquely provided to each vehicle. The vehicle ID may be identification information for the management system 1 or identification information used by, e.g., other systems. The identification information used by, e.g., the other systems includes, for example, a vehicle registration number, a vehicle number, a wireless call number (WCN), an on-board unit management number, and an electronic toll collection (ETC) card number.

The vehicle table is a table storing information on each vehicle 300. This information includes, as one example, the type of vehicle 300. The vehicle table stores, for each vehicle 300, the vehicle ID and the vehicle type in association with each other. Note that the vehicle type is one example of the type of moving body.

The incentive table is a table storing the amount of incentive provided to each user. The incentive table stores this amount with an association between the user ID and incentive information, as one example. The incentive information is information indicating the amount of incentive provided to the user. The server apparatus 100 provides an incentive to the user who provided the information indicating the result of charge of the vehicle 300 by the charger 400. The incentive is, for example, currency or electronic money. The incentive may be points. The incentive may be any one or more of the currency, the electronic money, and the points.

The communication interface 150 is an interface used when the server apparatus 100 makes communication via, e.g., the network NW.

The bus 160 includes a control bus, an address bus, and a data bus, and transmits a signal exchanged between the components of the server apparatus 100.

The terminal apparatus 200 is, for example, a smartphone, a tablet terminal, or a laptop PC. The terminal apparatus 200 may be an on-board apparatus of the vehicle 300. Alternatively, an apparatus such as a smartphone, a tablet terminal, or a laptop PC and an on-board apparatus of the vehicle 300 may cooperate with each other to operate as the terminal apparatus 200. The on-board apparatus includes, for example, an electronic control unit (ECU), a car navigation system, and an ETC on-board unit. The terminal apparatus 200 includes, as one example, a processor 210, a ROM 220, a RAM 230, an auxiliary storage device 240, a first communication interface (I/F) 250, a second communication interface (I/F) 260, an input device 270, and an output device 280. These components are connected to each other via, e.g., a bus 290.

The processor 210 is a center component of a computer that performs processing necessary for operation of the terminal apparatus 200, such as arithmetic processing and control, and performs, e.g., various types of arithmetic processing and processing. The processor 210 includes, for example, a CUP, a MPU, a SoC, a DSP, a GPU, an ASIC, a PLD, and an FPGA. Alternatively, the processor 210 may be a combination of some of these components. Alternatively, the processor 210 may be a combination of these components and, e.g., a hardware accelerator. The processor 210 controls each component to implement various functions of the terminal apparatus 200 based on programs stored in the ROM 220 or the auxiliary storage device 240, such as firmware, system software, and application software. Moreover, the processor 210 executes later-described processing based on these programs. Note that some or all of the programs may be incorporated into a circuit of the processor 210.

The ROM 220 and the RAM 230 are main storage devices of the computer having the processor 210 as the center. The ROM 220 is a non-volatile memory used solely for reading data. The ROM 220 stores, for example, the firmware among the above-described programs. Moreover, the ROM 220 also stores, e.g., data used when the processor 210 performs various types of processing.

The RAM 230 is a memory used for reading and writing data. The RAM 230 is used as, e.g., a work area for storing data temporarily used when the processor 210 performs various types of processing. The RAM 230 is typically a volatile memory.

The auxiliary storage device 240 is an auxiliary storage device of the computer having the processor 210 as the center. The auxiliary storage device 240 includes, for example, an EEPROM, an HDD, and a flash memory. The auxiliary storage device 240 stores, for example, the system software and the application software among the above-described programs. Moreover, the auxiliary storage device 240 stores, e.g., data used when the processor 210 performs various types of processing, data generated by the processing of the processor 210, and various setting values.

The first communication I/F 250 is an interface used when the terminal apparatus 200 communicates with the vehicle 300 or a battery 310. This communication may be wired or wireless communication. This communication may be made via the network NW.

The second communication I/F 260 is an interface used when the terminal apparatus 200 makes communication via, e.g., the network NW. Note that the first communication I/F 250 may also serve as the second communication I/F 260.

The input device 270 receives operation by an operator (hereinafter merely referred to as an “operator”) of the terminal apparatus 200. The input device 270 includes, for example, a keyboard, a keypad, a touch pad, a mouse, and a controller. Alternatively, the input device 270 may be a device for voice input.

The output device 280 displays a screen for notifying, e.g., the operator of various types of information. The output device 280 is, for example, a display such as a liquid crystal display or an organic electroluminescence (EL) display. Alternatively, a touch panel may be used as the input device 270 and the output device 280. That is, a display panel of the touch panel may be used as the output device 280, and a touch-input pointing device of the touch panel may be used as the input device 270.

The bus 290 includes, e.g., a control bus, an address bus, and a data bus, and transmits a signal exchanged between the components of the terminal apparatus 200.

The vehicle 300 is an electric vehicle travelable by the battery 310 chargeable by an external power supply, such as an automobile, a motorcycle, or an electric bicycle. The vehicle 300 is, for example, an electric vehicle (EV) and a plug-in hybrid electric vehicle (PHEV). The vehicle 300 includes the battery 310, as one example. Note that the vehicle 300 is one example of a moving body.

The battery 310 is, for example, a chargeable secondary battery or capacitor. The battery 310 is a power source that supplies electric power to each component of the vehicle 300.

The charger 400 is a charger that charges the battery 310 for the vehicle 300. The charger 400 is installed, for example, at a charge station, a charge space, or a parking. That is, the charger 400 is a charger usable by an unspecified large number of people.

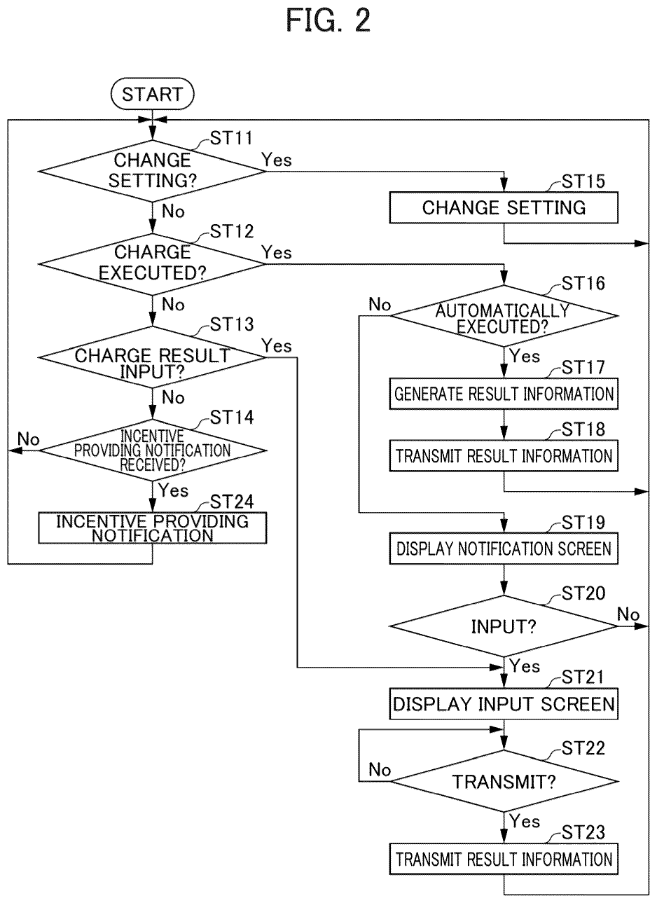

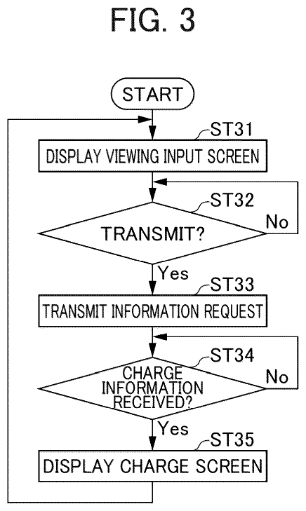

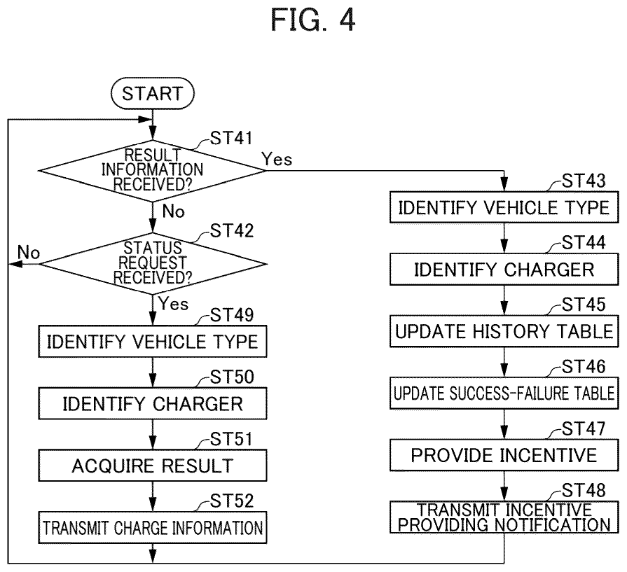

Hereinafter, operation of the management system 1 according to the embodiment will be described based on, e.g., FIGS. 2 to 4. Note that the contents of processing in the operation described below are one example and various types of processing providing similar results can be used as necessary. FIGS. 2 and 3 are flowcharts showing one example of processing by the processor 210 of the terminal apparatus 200. The processor 210 executes, for example, the processing of FIGS. 2 and 3 based on the programs stored in the ROM 220 or the auxiliary storage device 240. FIG. 4 is a flowchart showing one example of processing by the processor 110 of the server apparatus 100. The processor 110 executes, for example, the processing of FIG. 4 based on the programs stored in the ROM 120 or the auxiliary storage device 140.

In Step ST11 of FIG. 2, the processor 210 of the terminal apparatus 200 determines whether or not the setting is changed. The processor 210 determines that the setting is changed, for example, in a case where the operator performs an operation of instructing a setting change. In a case where the setting is not changed, the processor 210 determines Step ST11 as No, and proceeds to Step ST12.

In Step ST12, the processor 210 determines whether or not the vehicle 300 has been charged. The processor 210 communicates with the vehicle 300 or the battery 310 via the first communication I/F 250, thereby detecting whether or not the vehicle 300 has been charged. In a case where the terminal apparatus 200 is the on-board apparatus, the vehicle 300 targeted for determination on whether or not the vehicle 300 has been charged is, for example, the vehicle 300 including the terminal apparatus 200 as the on-board apparatus. In a case where the terminal apparatus 200 is not the on-board apparatus, the vehicle 300 targeted for determination on whether or not the vehicle 300 has been charged is, for example, the vehicle 300 associated with the terminal apparatus 200 in advance. Here, the vehicle 300 having been charged indicates that the vehicle 300 has been charged regardless of whether or not charge is successfully performed. In a case where the processor 210 does not detect that the vehicle 300 has been charged, the processor 210 determines Step ST12 as No, and proceeds to Step ST13.

In Step ST13, the processor 210 determines whether or not the operator inputs a charge result. For example, in a case where the operator has performed an operation of inputting the charge result, the processor 210 determines that the charge result is input. This operation is performed, for example, in a case where the terminal apparatus 200 does not have a function of detecting charge of the vehicle 300 or a case where such detection is not successfully made. The input of the charge result will be described later. In a case where the processor 210 does not determine that the charge result is input, the processor 210 determines Step ST13 as No, and proceeds to Step ST14.

In Step ST14, the processor 210 determines whether or not the second communication I/F 260 has received an incentive providing notification. In a case where the incentive providing notification is not received, the processor 210 determines Step ST14 as No, and returns to Step ST11. The processor 210 is in a standby state of repeating Steps ST11 to ST14 until the setting is changed, the vehicle 300 is charged, the charge result is input, or the incentive providing notification is received.

In a case where the processor 210 determines that the setting is changed while being in the standby state of repeating Steps ST11 to ST14, the processor 210 determines Step ST11 as Yes, and proceeds to Step ST15.

In Step ST15, the processor 210 changes the setting based on the contents of operation by the operator. The contents of the setting are stored in at least one of the auxiliary storage device 140 of the server apparatus 100 or the auxiliary storage device 240 of the terminal apparatus 200. The contents of the setting include, for example, a setting of automatically transmitting the charge result. The contents of the setting include, for example, information indicating which vehicle 300 the user uses and information indicating the type of vehicle 300. The processor 210 returns to Step ST11 after the processing of Step ST15.

In a case where the processor 210 detects that the vehicle 300 has been charged while being in the standby state of repeating Steps ST11 to ST14, the processor 210 determines Step ST12 as Yes, and proceeds to Step ST16.

In Step ST16, the processor 210 acquires the contents of the setting, for example, from the auxiliary storage device 140 of the server apparatus 100 or the auxiliary storage device 240 of the terminal apparatus 200. Then, the processor 210 determines whether or not the contents of the setting indicate the setting of automatically transmitting the charge result. In a case where the contents indicate the setting of automatically transmitting the charge result, the processor 210 determines Step ST16 as Yes, and proceeds to Step ST17.

In Step ST17, the processor 210 generates result information. The result information is information notifying the charge result. The result information includes, as one example, vehicle type identification information, charger identification information, date-and-time information, success-failure information, DC-AC information, and wireless information. In a case where charge is unsuccessfully performed, the result information may include reason information. In a case where charge is successfully performed, the result information may include power information and electric energy information. Note that in a case where there is unknown information among various types of information above, the processor 210 may generate result information including information indicating that such information is unknown. The processor 210 acquires each type of information used for generating the result information, for example, from at least one of the server apparatus 100, the auxiliary storage device 240, the vehicle 300, or the charger 400. Note that in a case where other acquisition sources are described below, the processor 210 may acquire the information from these acquisition sources. The processor 210 acquires the information, for example, from the server apparatus 100 via the second communication I/F 260. The processor 210 acquires the information, for example, from the vehicle 300 via the first communication I/F 250. The processor 210 acquires the information, for example, from the charger 400 via the second communication I/F 260. Alternatively, the processor 210 acquires the information, for example, from the charger 400 via the first communication I/F 250 and the vehicle 300.

The vehicle type identification information is information from which the type of vehicle 300 charged by the charger 400 is identifiable by the server apparatus 100. The vehicle type identification information includes, for example, at least one of the vehicle ID of the vehicle 300, the user ID of the user using the vehicle 300, or vehicle type information. The vehicle type information is information indicating the type of vehicle 300. Note that the vehicle type identification information is one example of type identification information identifying the type of moving body.

The charger identification information is information from which the charger 400 having charged the vehicle 300 is identifiable by the server apparatus 100. The charger identification information is, for example, location information indicating the installation location of the charger 400 or the charger ID. Note that the processor 210 acquires the location information, for example, using a global navigation satellite system (GNSS) such as a global positioning system (GPS). Alternatively, the processor 210 may acquire the location information using an indoor positioning system.

The date-and-time information is information indicating the date and time of charge. Alternatively, the date-and-time information may be information indicating the date of charge.

The success-failure information is information indicating whether or not charge has been successfully performed.

The DC-AC information is information indicating whether electric power used for charge or electric power to be used for charge is DC or AC.

The wireless information is information indicating whether charge of the vehicle 300 is wireless charge (wireless power transfer (WPT)) or wired charge.

Failure information is information indicating a reason why charge is unsuccessfully performed. The reason why charge is unsuccessfully performed may include, for example, the standards of the vehicle 300 not conforming to the standards of the charger 400, the software version of the vehicle 300 or the charger 400 being old, the abnormality of the vehicle 300, the abnormality of the charger 400, and the abnormality of an electric system that supplies electric power to the charger 400. Note that the abnormality includes breakdown.

The power information is information indicating the magnitude of electric power used for charge.

The energy information is information indicating the charged electric energy.

In Step ST18, the processor 210 instructs the second communication I/F 260 to transmit the result information generated in Step ST17 to the server apparatus 100. In response to the transmission instruction, the second communication I/F 260 transmits the result information to the server apparatus 100. The transmitted result information is received by the communication interface 150 of the server apparatus 100.

In a case where the setting is not the setting of automatically transmitting the charge result, the processor 210 determines Step ST16 as No, and proceeds to Step ST19.

In Step ST19, the processor 210 generates an image corresponding to a notification screen. Then, the processor 210 instructs the output device 280 to display the generated image. In response to the display instruction, the output device 280 displays the notification screen.

The notification screen is a screen for notifying the operator that the vehicle 300 has been charged. The notification screen includes, as one example, an input button and an end button. The input button is a button operated by the operator when the operator inputs the charge result. The end button is a button operated when the displayed notification screen is closed without inputting the charge result.

In Step ST20, the processor 210 determines whether or not the operator inputs the charge result. For example, in a case where the input button is operated, the processor 210 determines that the charge result is input. For example, in a case where the end button is operated, the processor 210 determines that the charge result is not input. In a case where the processor 210 determines that the charge result is not input, the processor 210 determines Step ST20 as No, and returns to Step ST11. On the other hand, in a case where the processor 210 determines that the charge result is input, the processor 210 determines Step ST20 as Yes, and proceeds to Step ST21.

In a case where the processor 210 determines that the charge result is input while being in the standby state of repeating Steps ST11 to ST14, the processor 210 determines Step ST13 as Yes, and proceeds to Step ST21.

In Step ST21, the processor 210 generates an image corresponding to an input screen. Then, the processor 210 instructs the output device 280 to display the generated image. In response to the display instruction, the output device 280 displays the input screen.

The input screen is a screen for inputting the result of charge of the vehicle 300 by the charger 400. As one example, the vehicle type identification information, the charger identification information, the date-and-time information, the success-failure information, the DC-AC information, the wireless information, the reason information, the power information, and the energy information are inputtable to the input screen. The input screen includes input fields to which these types of information are input. The input screen further includes a transmission button, as one example. The transmission button is a button operated by the operator when the terminal apparatus 200 is instructed to transmit each type of information input to the input screen.

The processor 210 may automatically input the information to each input field of the input screen. The processor 210 acquires each type of information input to the input field, for example, from at least one of the server apparatus 100, the auxiliary storage device 240, the vehicle 300, or the charger 400. The information acquired by the processor 210 is limited to known information. Note that the processor 210 may input a default value as, e.g., an entry example to the input field of the input screen.

The operator does not need to input the information to all the input fields. Note that in a case where the information input to the input screen is transmitted, it may be essential to input the vehicle type identification information, the charger identification information, and the success-failure information to the input screen.

In Step ST22, the processor 210 determines whether or not each type of information input to the input screen is transmitted to the server apparatus 100. For example, in a case where the transmission button displayed on the input screen is operated, the processor 210 determines that the information is transmitted. In a case where the processor 210 does not determine that each type of information is transmitted, the processor 210 determines Step ST22 as No, and repeats the processing of Step ST22. On the other hand, in a case where the processor 210 determines that each type of information is transmitted, the processor 210 determines Step ST22 as Yes, and proceeds to Step ST23.

In Step ST23, the processor 210 generates the result information using the information input to the input screen. The processor 210 generates the result information, and thereafter, instructs the second communication I/F 260 to transmit the result information to the server apparatus 100. In response to the transmission instruction, the second communication I/F 260 transmits the result information to the server apparatus 100. The transmitted result information is received by the communication interface 150 of the server apparatus 100. The processor 210 performs the processing of Step ST23, and thereafter, returns to Step ST11.

With the above-described configuration, the processor 210 cooperates with the second communication I/F 260 to perform the processing of Step ST18 or ST23, thereby functioning as one example of a transmitter that transmits the charger identification information identifying the charger and the type identification information identifying the type of moving body. Moreover, the processor 210 controls the second communication I/F 260 to perform the processing of Step ST18 or ST23, thereby functioning as one example of a transmission controller that controls a communication device to transmit the charger identification information and the type identification information.

Meanwhile, in Step ST41 of FIG. 4, the processor 110 of the server apparatus 100 determines whether or not the result information has been received by the communication interface 150. In a case where the result information is not received, the processor 110 determines Step ST41 as No, and proceeds to Step ST42.

In Step ST42, the processor 110 determines whether or not a status request has been received by the communication interface 150. In a case where the status request is not received, the processor 110 determines Step ST42 as No, and returns to Step ST41. The processor 110 is in a standby state of repeating Steps ST41, ST42 until the result information or the status request is received.

In a case where the result information is received while the processor 110 is in the standby state of repeating Steps ST41, ST42, the processor 110 determines Step ST41 as Yes, and proceeds to Step ST43.

With the above-described configuration, the processor 110 cooperates with the communication interface 150 to receive the result information, thereby functioning as one example of an input that receives input of the success-failure information indicating whether or not the moving body has been successfully charged by the charger, the charger identification information identifying the charger, and the type identification information identifying the type of moving body. Moreover, the processor 110 controls the communication interface 150 to receive the result information, thereby functioning as one example of an input controller that controls a communication device to receive input of the success-failure information indicating whether or not the moving body has been successfully charged by the charger, the charger identification information identifying the charger, and the type identification information identifying the type of moving body.

In Step ST43, the processor 110 identifies the vehicle type indicated by the vehicle type identification information in the result information received in Step ST41. In a case where the vehicle type identification information includes the vehicle type information, the processor 110 identifies the vehicle type indicated by the vehicle type information as the vehicle type indicated by the vehicle type identification information. In a case where the vehicle type identification information includes the user ID, the processor 110 acquires the vehicle ID associated with the user ID with reference to the user table. Then, the processor 110 acquires the vehicle type associated with the vehicle ID with reference to the vehicle table. In this manner, the processor 110 identifies the vehicle type indicated by the vehicle type identification information. In a case where the vehicle type identification information includes the vehicle ID, the processor 110 acquires the vehicle type associated with the vehicle ID with reference to the vehicle table. In this manner, the processor 110 identifies the vehicle type indicated by the vehicle type identification information.

In Step ST44, the processor 110 identifies the charger 400 indicated by the charger identification information in the result information received in Step ST41. In a case where the charger identification information includes the charger ID, the processor 110 acquires the charger ID to identify the charger 400. In a case where the charger identification information includes the location information, the processor 110 identifies the charger 400 closest to the location information with reference to the charger table. Then, the processor 110 acquires the charger ID of the charger 400.

In Step ST45, the processor 110 updates the history table using the result information received in Step ST42 and the information on the vehicle type identified in Step ST43 and the charger 400 identified in Step ST44, and adds the information to the history.

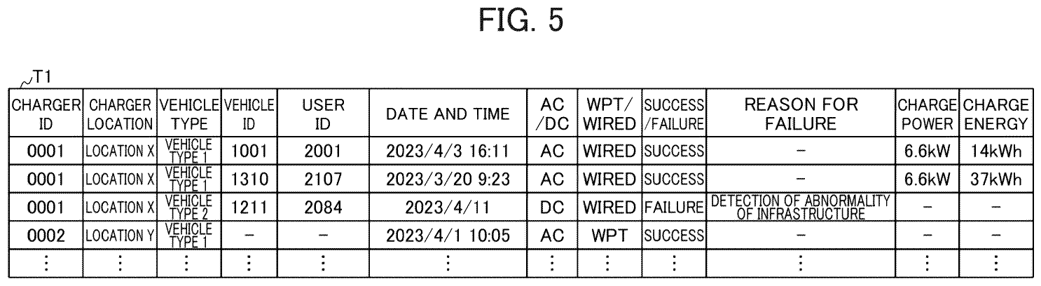

FIG. 5 is one example of a history table T1. The processor 110 adds one line to the history table T1 and writes various types of information in the added line, for example. Note that the processor 110 may leave a field for unknown information blank. In FIG. 5, the blank field is indicated by “-”.

Note that in a case where the reason indicated by the reason information is a particular reason, the processor 110 may skip the processing of Steps ST45 to ST48 without updating the history table T1. The particular reason is, for example, the abnormality of the vehicle 300 or the breakdown of the vehicle 300.

In Step ST46, the processor 110 updates a success-failure table T2 using the updated contents of the history table T1.

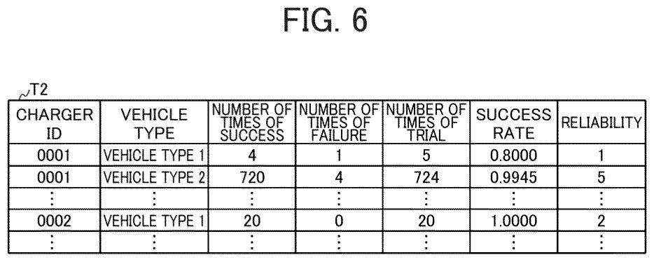

FIG. 6 is one example of the success-failure table T2. The success-failure table T2 shows, as one example, the association of the combination of the charger ID and the vehicle type with overall success-failure information and reliability.

The overall success-failure information includes, for example, the number of times of success, the number of times of failure, the number of times of trial, and a success rate. The overall success-failure information associated with the combination of the charger ID and the vehicle type indicates the overall result of charge of the vehicle type by the charger 400 identified by the charger ID. The number of times of success is the number of times of successful charge. The number of times of failure is the number of times of unsuccessful charge. The number of times of trial is the sum of the number of times of success and the number of times of failure. The success rate is obtained by dividing the number of times of success by the number of times of trial. The overall success-failure information may include a failure rate. The failure rate is obtained by dividing the number of times of failure by the number of times of trial. The overall success-failure information may include at least one of the number of times of success, the number of times of failure, the success rate, or the failure rate.

Note that the processor 110 may obtain the number of times of success, the number of times of failure, the number of times of trial, and the success rate using only the history of charge performed in the latest predetermined period in the history table T1.

The processor 110 calculates the reliability using the number of times of trial. The reliability is a value that increases as the number of times of trial in the latest predetermined period increases. The reliability is a value indicating the degree to which the overall success-failure information is reliable. The fewer the number of times of trial, the greater the error in the success rate and the failure rate. The reliability indicates the degree of such an error. Note that the predetermined period may be an overall period.

With the above-described configuration, the processor 110 performs at least one of Step ST45 or Step ST46, thereby functioning as one example of a storage that stores, in the storage device, the result of charge of the moving body whose type is identified by the type identification information by the charger identified by the charger identification information based on the information input to the input such that the charger used for charge and the type of moving body targeted for charge are recognized.

Moreover, the processor 110 calculates the reliability, thereby functioning as one example of a calculator that calculates the reliability that increases as the number of times of charge of the moving body whose type is identified by the type identification information by the charger identified by the charger identification information increases.

Further, the processor 110 calculates at least one of the success rate or the failure rate, thereby functioning as one example of a calculator that calculates at least one of the success rate or failure rate of charge of the moving body whose type is identified by the type identification information by the charger identified by the charger identification information.

In Step ST47, the processor 110 updates the incentive table, and provides the incentive to the user as a result information transmission source. That is, the processor 110 adds the amount of incentive to be newly provided to the amount of incentive indicated by the incentive information associated with the user ID in the vehicle type identification information in the result information received in Step ST41. Note that in a case where the user ID is unknown, the processor 110 may skip the processing of Steps ST47, ST48.

The amount of incentive to be provided may be fixed or vary according to a condition. The amount of incentive may be zero according to a condition. The processor 110 may determine the amount of incentive, for example, according to a difference in the date and time between the history added in Step ST45 and the history which is before the added history and is latest in the date and time in the history associated with the vehicle type identified in Step ST44 and the charger ID of the charger 400 identified in Step ST45. For example, in a case where the difference is a predetermined value or more, the processor 110 increases the amount of incentive. For example, in a case where the difference is less than the predetermined value, the processor 110 sets the amount of incentive to zero. For example, the processor 110 increases the amount of incentive as the difference increases. Note that the date and time in the history which is before the history added in Step ST45 and is latest in the date and time is one example of the date and time of charge in the latest result stored in the storage device before the success-failure information is input.

The processor 110 transfers the incentive to the account of each user, for example, in real time or at a later date. Alternatively, the processor 110 may provide at least one of the currency, the electronic money, or the points to the user by other methods.

With the above-described configuration, the processor 110 performs the processing of Step ST47, thereby functioning as one example of a provider that provides the incentive to the transmission source of the information input to the input.

In Step ST48, the processor 110 generates the incentive providing notification. The incentive providing notification includes information indicating the amount of incentive provided in Step ST47. The incentive providing notification is information notifying the amount. The processor 110 generates the incentive providing notification, and thereafter, instructs the communication interface 150 to transmit the incentive providing notification to the terminal apparatus 200. In response to the transmission instruction, the communication interface 150 transmits the incentive providing notification to the terminal apparatus 200. The transmitted incentive providing notification is received by the second communication I/F 260 of the terminal apparatus 200. The processor 110 performs the processing of Step ST48, and thereafter, returns to Step ST41.

In a case where the incentive providing notification is received while the processor 210 of the terminal apparatus 200 is in the standby state of repeating Steps ST11 to ST14 of FIG. 2, the processor 210 determines Step ST14 as Yes, and proceeds to Step ST24.

In Step ST24, the processor 210 generates an image corresponding to an incentive providing screen. Then, the processor 210 instructs the output device 280 to display the generated image. In response to the display instruction, the output device 280 displays the incentive providing screen. The processor 210 performs the processing of Step ST24, and thereafter, returns to Step ST11.

The incentive providing screen is a screen for notifying the operator of the amount of incentive in the incentive providing notification received in Step ST14. The incentive providing screen includes an image indicating the amount, as one example.

For example, the overall success-failure information can be viewed via the management system 1. Viewing of, e.g., the overall success-failure information will be described with reference to FIGS. 3 and 4.

In Step ST31 of FIG. 3, the processor 210 of the terminal apparatus 200 generates an image corresponding to a viewing input screen. Then, the processor 210 instructs the output device 280 to display the generated image. In response to the display instruction, the output device 280 displays the viewing input screen.

The viewing input screen is a screen for inputting information necessary for viewing, e.g., the overall success-failure information. As one example, the vehicle type identification information and the charger identification information are inputtable to the viewing input screen. The viewing input screen includes input fields to which these types of information are input. Note that the processor 210 may automatically input the information to each input field of the viewing input screen. Moreover, the viewing input screen includes a transmission button, as one example. The transmission button is a button operated by the operator when the terminal apparatus 200 is instructed to transmit each type of information input to the viewing input screen.

In Step ST32, the processor 210 determines whether or not each type of information input to the viewing input screen is transmitted to the server apparatus 100. For example, in a case where the transmission button displayed on the viewing input screen is operated, the processor 210 determines that the information is transmitted. In a case where the processor 210 does not determine that each type of information is not transmitted, the processor 210 determines Step ST32 as No, and repeats the processing of Step ST32. On the other hand, in a case where the processor 210 determines that each type of information is transmitted, the processor 210 determines Step ST32 as Yes, and proceeds to Step ST33.

In Step ST33, the processor 210 generates an information request. The information request includes, as one example, the vehicle type identification information and charger identification information input to the viewing input screen. The information request is information requesting transmission of the overall success-failure information and reliability identified by the vehicle type identification information and the charger identification information and the latest charge history. The processor 210 generates the information request, and thereafter, instructs the second communication I/F 260 to transmit the information request to the server apparatus 100.

In response to the transmission instruction, the second communication I/F 260 transmits the information request to the server apparatus 100. The transmitted information request is received by the communication interface 150 of the server apparatus 100.

In a case where the status request is received while the processor 110 of the server apparatus 100 is in the standby state of repeating Steps ST41, ST42 of FIG. 4, the processor 110 determines Step ST42 as Yes, and proceeds to Step ST47.

In Step ST49, the processor 110 identifies the vehicle type indicated by the vehicle type identification information in the information request received in Step ST42, as in Step ST43.

In Step ST50, the processor 110 identifies the charger 400 indicated by the charger identification information in the information request received in Step ST42, as in Step ST44.

In Step ST51, the processor 110 acquires the overall success-failure information and the reliability with reference to the success-failure table T2. The overall success-failure information and the reliability are the overall success-failure information and reliability associated with the charger ID of the charger 400 identified in Step ST44 and the vehicle type identified in Step ST43. Moreover, the processor 110 acquires the latest charge history with reference to the history table T1. The charge history is latest in the date and time in the history associated with the charger ID of the charger 400 identified in Step ST44 and the vehicle type identified in Step ST43.

In Step ST52, the processor 110 generates charge information. The charge information includes the overall success-failure information, reliability, and history acquired in Step ST51. The charge information is information for notifying the overall success-failure information, the reliability, and the history. Note that the history does not include the vehicle ID and the user ID. The processor 110 generates the charge information, and thereafter, instructs the communication interface 150 to transmit the charge information to the terminal apparatus 200 as a status request transmission source. In response to the transmission instruction, the communication interface 150 transmits the charge information to the terminal apparatus 200. The transmitted charge information is received by the second communication I/F 260 of the terminal apparatus 200. The processor 110 performs the processing of Step ST52, and returns to Step ST41.

With the above-described configuration, the processor 110 cooperates with the communication interface 150 to perform the processing of Step ST42 and transmit the overall success-failure information, thereby functioning as one example of a communicator that transmits at least one of the number of times of success, the number of times of failure, the success rate, or the failure rate of charge of the moving body whose type is identified by the type identification information by the charger identified by the charger identification information in response to reception of the charger identification information and the type identification information from the terminal apparatus. Moreover, the processor 110 cooperates with the communication interface 150 to perform the processing of Step ST42 and transmit the history, thereby functioning as one example of a communicator that transmits the latest result of charge of the moving body whose type is identified by the type identification information by the charger identified by the charger identification information in response to reception of the charger identification information and the type identification information from the terminal apparatus.

Meanwhile, in Step ST34 of FIG. 3, the processor 210 of the terminal apparatus 200 waits for the second communication I/F 260 to receive the charge information. In a case where the charge information is received, the processor 210 determines Step ST34 as Yes, and proceeds to Step ST35.

In Step ST35, the processor 210 generates an image corresponding to a charge screen. Then, the processor 210 instructs the output device 280 to display the generated image. In response to the display instruction, the output device 280 displays the charge screen. The processor 210 performs the processing of Step ST35, and returns to Step ST31.

The charge screen is a screen for notifying the operator of the contents of the overall success-failure information, the reliability, and the history in the charge information received in Step ST33. The charge screen includes, as one example, an image indicating the overall success-failure information, the reliability, and the history.

According to the management system 1 of the embodiment, the server apparatus 100 receives input of success-failure information, charger identification information, and vehicle type identification information. Then, the server apparatus 100 of the embodiment stores the overall charge success-failure information such that the charger 400 used for charge and the type of vehicle 300 targeted for charge are recognized. With this configuration, the server apparatus 100 of the embodiment can grasp the status of charge of each vehicle type by each charger 400. With use of the server apparatus 100 of the embodiment, the user can recognize the status of charge of each vehicle type by each charger 400.

According to the management system 1 of the embodiment, the server apparatus 100 receives the charger identification information and the vehicle type identification information from the terminal apparatus 200. In response to such reception, the server apparatus 100 of the embodiment transmits, to the terminal apparatus 200, the overall success-failure information on charge of the vehicle type identified by the vehicle type identification information by the charger 400 identified by the charger identification information. With this configuration, the user can obtain the overall success-failure information on charge of a particular vehicle type by a particular charger 400.

According to the management system 1 of the embodiment, the server apparatus 100 receives the charger identification information and the vehicle type identification information from the terminal apparatus 200. In response to such reception, the server apparatus 100 of the embodiment transmits, to the terminal apparatus 200, the latest result of charge of the vehicle type identified by the vehicle type identification information by the charger 400 identified by the charger identification information. With this configuration, the user can obtain the latest result of charge of a particular vehicle type by a particular charger 400.

According to the management system 1 of the embodiment, the server apparatus 100 obtains the reliability that increases as the number of times of trial increases. With this configuration, the user can grasp how much the overall success-failure information is reliable.

According to the management system 1 of the embodiment, the server apparatus 100 calculates at least one of the success rate or the failure rate. With this configuration, the user can recognize the probability that charge by the charger 400 is available.

According to the management system 1 of the embodiment, the server apparatus 100 provides the incentive to the user as the result information transmission source. The incentive motivates the user to transmit the result information.

According to the management system 1 of the embodiment, the server apparatus 100 determines the amount of incentive according to the date and time of the history. In a case where the date and time of the latest history is old, if the amount of incentive increases, the user can use the charger 400 with a smaller number of records of the history.

The above-described embodiment may include the following modifications. In the above-described embodiment, the server apparatus 100 transmits the latest charge history to the terminal apparatus 200. However, the server apparatus 100 may transmit, to the terminal apparatus 200, N charge histories counted from the latest history. N is an integer of one or more. The value of N is determined, for example, based on operation by the operator. Alternatively, the value of N may be determined by, e.g., a manager or designer of the management system 1.

The terminal apparatus 200 may be unable to automatically transmit the charge result. Alternatively, the terminal apparatus 200 may be able to only automatically transmit the charge result.

In the above-described embodiment, the case where the vehicle 300 is charged has been described as an example. However, the management system of the embodiment is also applicable to a case where a moving body other than the vehicle 300 is charged. The moving body other than the vehicle 300 may include, for example, a bicycle, an aircraft, and a ship. In the case of the moving body other than the vehicle 300, the management system of the embodiment may use an aircraft type or a ship type instead of the vehicle type. The aircraft type or the ship type is one example of the type of moving body. With the above-described configuration, the server apparatus of the embodiment can grasp the status of charge of each type of moving body by the charger.

The moving body of the embodiment may be an unmanned moving body.

Part of the processing performed by the terminal apparatus 200 in the above-described embodiment may be performed by the server apparatus 100. Part of the processing performed by the server apparatus 100 in the above-described embodiment may be performed by the terminal apparatus 200.

An apparatus other than the server apparatus 100 may include the storage device of the embodiment.

Each apparatus of the embodiment may include a plurality of apparatuses.

The processor 110 and the processor 210 may implement, by a hardware configuration of a circuit, part or the entirety of the processing implemented by the programs in the above-described embodiments.

The programs for implementing the processing of the embodiment are delivered, for example, with stored in a non-transitory computer readable storage medium in the apparatus. However, the apparatus may be delivered with no programs stored therein. Then, the programs may be separately delivered and written in the apparatus. The programs can be delivered, for example, with recorded in a removable non-transitory computer readable storage medium or with downloaded via a network such as the Internet or a LAN.

The embodiment of the present invention has been described above, but is an example and is not intended to limit the scope of the present invention. The embodiment of the present invention can be implemented in various forms without departing from the gist of the present invention.

### EXPLANATION OF REFERENCE NUMERALS

1 Management System
100 Server Apparatus
110, 210 Processor
120, 220 ROM
130, 230 RAM
140, 240 Auxiliary Storage Device
141 Charger DB
142 User DB
150 Communication Interface
160, 290 Bus
200 Terminal Apparatus
250 First Communication I/F
260 Second Communication I/F
270 Input Device
280 Output Device
300 Vehicle
310 Battery
400 Charger

What is claimed is:

1. A management apparatus, comprising:
an input that receives input of success-failure information indicating whether or not a moving body has been successfully charged by a charger, charger identification information identifying the charger, and type identification information identifying a type of the moving body; and
a storage that stores, in a storage device, a result of charge of the moving body whose type is identified by the type identification information by the charger identified by the charger identification information based on the information input to the input such that the charger used for the charge and the type of the moving body targeted for the charge are recognized.

2. The management apparatus according to claim 1, further comprising: a communicator that transmits, in response to reception of the charger identification information and the type identification information from a terminal apparatus, at least one of the number of times of success, the number of times of failure, a success rate, or a failure rate of the charge of the moving body whose type is identified by the type identification information by the charger identified by the charger identification information.

3. The management apparatus according to claim 1, further comprising: a communicator that transmits, in response to reception of the charger identification information and the type identification information from a terminal apparatus, a latest result of the charge of the moving body whose type is identified by the type identification information by the charger identified by the charger identification information.

4. The management apparatus according to claim 1, further comprising: a calculator that calculates a reliability that increases as the number of times of the charge of the moving body whose type is identified by the type identification information by the charger identified by the charger identification information increases.

5. The management apparatus according to claim 1, further comprising: a calculator that calculates at least one of a success rate or a failure rate of the charge of the moving body whose type is identified by the type identification information by the charger identified by the charger identification information.

6. The management apparatus according to claim 1, further comprising: a provider that provides an incentive to a transmission source of the information input to the input.

7. The management apparatus according to claim 6, wherein the provider determines an amount of the incentive to be provided according to date and time of the charge in a latest result stored in the storage device before the success-failure information is input.

8. A management system comprising:
a terminal apparatus; and a management apparatus,
wherein the terminal apparatus includes a transmitter that transmits charger identification information identifying a charger and type identification information identifying a type of a moving body, and
the management apparatus includes
an input that receives input of success-failure information indicating whether or not the moving body has been successfully charged by the charger, the charger identification information, and the type identification information, and
a storage that stores, in a storage device, a result of charge of the moving body whose type is identified by the type identification information by the charger identified by the charger identification information based on the information input to the input such that the charger used for the charge and the type of the moving body targeted for the charge are recognized.

9. A terminal apparatus
forming a management system together with a management apparatus including an input that receives input of success-failure information indicating whether or not a moving body has been successfully charged by a charger, charger identification information identifying the charger, and type identification information identifying a type of the moving body and a storage that stores, in a storage device, a result of charge of the moving body whose type is identified by the type identification information by the charger identified by the charger identification information based on the information input to the input such that the charger used for the charge and the type of the moving body targeted for the charge are recognized, the terminal apparatus comprising:
a transmitter that transmits the charger identification information and the type identification information.

10. A non-transitory computer readable storage medium storing a program causing
a processor of a management apparatus including a communication device to function as
an input controller that controls the communication device to receive input of success-failure information indicating whether or not a moving body has been successfully charged by a charger, charger identification information identifying the charger, and type identification information identifying a type of the moving body, and
a storage that stores, in a storage device, a result of charge of the moving body whose type is identified by the type identification information by the charger identified by the charger identification information based on the information input to the communication device such that the charger used for the charge and the type of the moving body targeted for the charge are recognized.

11. A non-transitory computer readable storage medium storing a program causing
a processor of a terminal apparatus, which includes a communication device and forms a management system together with a management apparatus including an input that receives input of success-failure information indicating whether or not a moving body has been successfully charged by a charger, charger identification information identifying the charger, and type identification information identifying a type of the moving body and a storage that stores, in a storage device, a result of charge of the moving body whose type is identified by the type identification information by the charger identified by the charger identification information based on the information input to the input such that the charger used for the charge and the type of the moving body targeted for the charge are recognized, to function as
a transmission controller that controls the communication device to transmit the charger identification information and the type identification information.
